(19) United States
(12) Patent Application Publication
(10) Pub. No.: US 2017/0185992 A1
(43) Pub. Date: Jun. 29, 2017

(54) SOFTWARE APPLICATION FOR SMART CITY STANDARD PLATFORM

(71) Applicant: Zoomtoll, LLC, Columbia, MD (US)

(72) Inventors: Michael Campanaro, Cambridge, MD (US); Roger London, Columbia, MD (US)

(21) Appl. No.: 15/343,877

(22) Filed: Nov. 4, 2016

Related U.S. Application Data
(60) Provisional application No. 62/387,148, filed on Dec. 23, 2015.

(51) Int. Cl. G06Q 20/32; G06Q 20/10; G06F 17/30; H04W 4/02

(52) U.S. Cl. CPC G06Q 20/3224; H04W 4/021; G06Q 20/10; G06F 17/30241

(57) ABSTRACT

The present invention relates to systems and methods for software based applications used to track the geolocation of a user device or vehicle and determine an action based on the geolocation. The method may include obtaining a location of a user device. The method may also include determining a geolocation of the user device based on the obtained location. In addition, the method may include sending the user device a notification when the user device has entered the determined geolocation. The method may further include receiving information from the user device relating to an action chosen by the user device. Notably, the preferred embodiment lacks additional devices (sensors, cameras, RFID tags, parking meters, and the like).

### FIELD OF THE INVENTION

The present invention relates to systems and methods for software based applications used to track the location, and confirm the usage and passage of people and/or vehicles, and to determine if or when a payment should be made. The software based applications may be located on a user equipment or a user's mobile device, for example, a cell phone, tablet, portable computer or portable GPS, or loaded directly onto a vehicle. The software based application is capable of confirming or calculating the location of the user through various hardware and software associated with the mobile device and/or the vehicle, and thereby confirming usage. The software based application may also allow for payment if required by a third party, or desired by the user associated with the mobile device or vehicle.

### BACKGROUND OF THE INVENTION

Embodiments of the present invention solve many of the problems and/or overcome many of the drawbacks and disadvantages of the prior art by providing systems and methods for confirming usage of and making payment for access/use of a road, parking lot, or other venue. Traditional methods of making such payments to a facility operator of the road, parking lot, or venue, have involved a person associated with a vehicle waiting in a queue to make payment to a live person, or stopping to make payment by credit card to an electronic machine. Both of these methods have significant drawbacks. For instance, manual payment to a live person requires that the driver/user wait in a queue to make payment, and requires that the facility operator pay for a live person to handle the transactions. The user of manual payment therefore leads to a loss of revenue for the operator of the facility. The method involving electronic payment can also be cumbersome. This method requires that the user/vehicle stop, the credit payment method be presented, and for the machine to process the transactions. Further, the user/vehicle may again have to wait in a queue.

Still other methods include use of radio-frequency identification (RFID) devices associated with vehicles. Open road tolling systems have used active or passive methods for identifying customers, which include radio frequency transponders or visual images of the vehicle license plate among others. The cost association with the installation, management, distribution, and maintenance of the RFID or other hardware/equipment is labor and capital intensive. Toll systems traditionally use a stored value account for each customer, requiring an initial deposit to apply to future transactions. Before the stored value account is fully depleted, it is replenished from a customer's bank account, credit card, or cash payment at a service center. This is an inconvenient system for infrequent users of a toll system. In addition, one difficulty is that each RFID tag must be registered with a particular agency, and different agencies may use different toll collection technologies.

Likewise, RFIDs have been used for frequent visitors to parking locations. Again, a given RFID is only for specific garages, and therefore the customer may be required to obtain multiple RFIDs, or use different mechanisms of customer identification, such as visual images of the vehicle license plates.

There is a need, therefore, for an improved method of electronic payment in at least open road tolling, parking entities such as garages or other storage facilities, metros, buses, ferries, taxies, and other similar environments that reduces payment collection staffing, or expensive labor intensive hardware equipment.

### SUMMARY

A method may include obtaining a location of a user device. The method can also include determining a geolocation of the user device based on the obtained location. In addition, the method can include sending the user device a notification when the user device has entered the determined geolocation. Further, the method may include receiving information from the user device relating to an action chosen by the user device.

According to certain embodiments, an apparatus may include at least one memory including computer program code, and at least one processor. The at least one memory and the computer program code may be configured, with the at least one processor, to cause the apparatus at least to obtain a location of a user device, and to determine a geolocation of the user device based on the obtained location. The at least one memory and the computer program code may also be configured, with the at least one processor, to cause the apparatus at least to send the user device a notification when the user device has entered the determined geolocation. In addition, the at least one memory and the computer program code may be configured, with the at least one processor, to cause the apparatus at least to receive information from the user device relating to an action chosen by the user device.

An apparatus, in certain embodiments, may include means for obtaining a location of a user device. The apparatus may also include means for determining a geolocation of the user device based on the obtained location. In addition, the apparatus may include means for sending the user device a notification when the user device has entered the determined geolocation. Further, the apparatus may include means for receiving information from the user device relating to an action chosen by the user device.

According to certain embodiments, a non-transitory computer-readable medium encoding instructions that, when executed in hardware, perform a process. The process may include obtaining a location of a user device. The process may also include determining a geolocation of the user device based on the obtained location. In addition, the process may include sending the user device a notification when the user device has entered the determined geolocation. Further, the process may include receiving information from the user device relating to an action chosen by the user device.

According to certain embodiments, a computer program product encoding instructions for performing a process according to a method including obtaining a location of a user device. The method may also include determining a geolocation of the user device based on the obtained location. In addition, the method may include sending the user device a notification when the user device has entered the determined geolocation. Further, the method may include receiving information from the user device relating to an action chosen by the user device.

A method may include sending a location of a user device. The method can also include receiving at the user device a notification when the user device has entered a determined geolocation. In addition, the method can include choosing an action at the user device based on the received notification. Further, the method may include sending information from the user device relating to the chosen action.

According to certain embodiments, an apparatus may include at least one memory including computer program code, and at least one processor. The at least one memory and the computer program code may be configured, with the at least one processor, to cause the apparatus at least to send a location of a user device, and to receive at the user device a notification when the user device has entered a determined geolocation. The at least one memory and the computer program code may also be configured, with the at least one processor, to cause the apparatus at least to choose an action at the user device based on the received notification. In addition, the at least one memory and the computer program code may be configured, with the at least one processor, to cause the apparatus at least to send information from the user device relating to the chosen action.

An apparatus, in certain embodiments, may include means for sending a location of a user device. The apparatus may also include means for receiving at the user device a notification when the user device has entered a determined geolocation. In addition, the apparatus may include means for choosing an action at the user device based on the received notification. Further, the apparatus may include means for sending information from the user device relating to the chosen action.

According to certain embodiments, a non-transitory computer-readable medium encoding instructions that, when executed in hardware, perform a process. The process may include sending a location of a user device. The process may also include receiving at the user device a notification when the user device has entered a determined geolocation. In addition, the process may include choosing an action at the user device based on the received notification. Further, the process may include sending information from the user device relating to the chosen action.

According to certain embodiments, a computer program product encoding instructions for performing a process according to a method including sending a location of a user device. The method may also include receiving at the user device a notification when the user device has entered a determined geolocation. In addition, the method may include choosing an action at the user device based on the received notification. Further, the method may include sending information from the user device relating to the chosen action.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention.

FIG. 1 illustrates a system according to certain embodiments.

FIG. 2 illustrates a flow diagram according to certain embodiments.

### DETAILED DESCRIPTION OF THE PREFERRED EMBODIMENTS

Certain embodiments utilize the present global positioning system (GPS) and mobile cell communication infrastructure to allow a person to pay and/or use a at least open road tolling, parking entities such as garages or other storage facilities, metros, buses, ferries, taxies, and other similar environments system, with only a cell phone or vehicular hardware. Advantageously, these embodiments require no additional devices for example, cameras, beacons, sensors, RFID tags, or manual labor requirements by the system owners, such as the operator of a facility, or consumers.

Systems and methods are described for using various tools and procedures used by a software based application utilized with a mobile device and/or vehicle to determine the location of the mobile device or vehicle, confirm that at least one of passage/usage/patronage actually occurred, and determine whether a fee is required to be paid. In some embodiments the fee may be either automatically paid or optionally paid. When the fee is optionally paid, the user may have to agree to pay the fee before the payment is processes. The examples described herein are for illustrative purposes only. The software based application may be integrated with any hardware, such as a processor and/or memory of the user device, and be used to significantly improve the performance of the network and/or environment on which it operates. The systems and methods described herein may be used for many different industries and purposes, including any time a third party requires payment for use of a facility or road, or a user desires to make payment for such, for example, to toll roads, metro systems, taxis, buses, parking structures, ferries, drive through service windows, and/or other industries completely. In particular, the systems and methods may be used for any industry or purpose where payment to use or access a physical facility or physical transportation road or vehicle may be needed.

The embodiments discussed may first obtain a location of the user device or mobile device. The user device may have a processor, memory comprising computer code program, transceiver, and/or any other hardware needed to perform any of the processes described herein. The user device may be any electronic device associated with a user and that is carried by or with a user, such as, for example, a portable digital assistant (PDA) provided with wireless communication capabilities, portable media player, digital camera, navigation unit provided with wireless communication capabilities, cellular telephone, smart phone, multimedia device, digital watch, tablet, laptop computer, or any other type of mobile device or vehicle, or any combination therefore, based on preferences of the participant. The participant may be the user of the device. Accordingly, the system and method of the present invention is device agnostic, meaning that any device can be configured to work with the architecture of the present invention.

The software application is stored in a memory of the user device and may use information generated by or obtained through the user device to perform its functions. For example, a geolocation of the user device may be a function already present in the user device, and the software application merely calls for that information and uses it in a process. Alternative embodiments may be utilized with a vehicle having a geolocation system, such as a navigation unit, purchased by the consumer separately from the vehicle. A geolocation may be the identification of the real-world geographic location of an object.

The invention is intended to be a software platform used with or installed on a user device (such as a mobile device, a vehicle, or processors worn by the user in jewelry or clothing) that does not require additional hardware typically used today within a city or other municipality to track or use transportation facilities. For instance, one embodiment may not require any additional physical devices such as sensors, transmitters, and beacons, beyond those already existing in the user device, and may be used as a platform for payment in parking, public transportation, and/or tolls. In this embodiment, the city or municipality employing the software application may not incur the cost of purchasing and maintaining physical devices. Further, certain embodiment may have a consistent platform interface that may allow a user to access multiple services or areas of the city or municipality for paying tolls, finding parking, paying parking, paying and searching for public transportation, and the like.

Exemplary System Environment and Infrastructure

Certain embodiments may be embodied as a system, method, or computer program product. Accordingly, certain embodiments may take the form of an entirely software embodiment (including firmware, resident software, micro-code, etc.), while other embodiments may combine software and hardware aspects. In an entirely software embodiment, the product will still be run on a user device that includes at least a processor, a memory, and a transceiver

Any combination of one or more computer usable or computer readable medium(s), such as non-transitory computer readable medium, may be utilized. The computer-usable or computer-readable medium may be, for example but not limited to, an electronic, magnetic, optical, electromagnetic, infrared, or semiconductor system, memory, apparatus, device, or propagation medium. More specific examples (a non-exhaustive list) of the computer-readable medium would include the following:
a portable computer diskette.
a hard disk drive (HDD),
a random access memory (RAM),
flash memory
a read-only memory (ROM),
an erasable programmable read-only memory (EPROM or Flash memory),
a portable compact disc read-only memory (CDROM),
any other memory that is fixed or removable, and/or
an optical storage device.

The computer usable program code (software) may be transmitted using any appropriate transmission media via a network. Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The programming language may be high-level programming language, such as C++, or a low-level programming language, such as a machine language or assembler. The program code may execute entirely on the user's device, partly on the user's device, as a stand-alone software package, partly on the user's device and partly on a remote computer, or entirely on the remote computer or server. In the latter scenario, the remote computer may be connected to the user's device through any type of network. This may include, for example, a local area network (LAN) or a wide area network (WAN), Bluetooth, Wireless LAN, satellite, or cellular network, or the connection may be made to an external computer, for example, through the Internet using an Internet Service Provider.

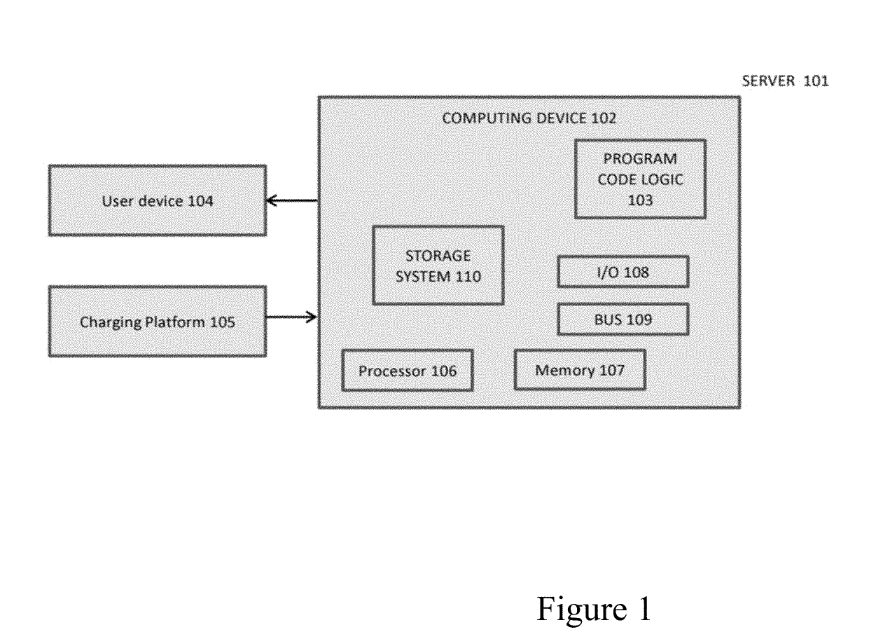

FIG. 1 illustrates a system according to certain embodiments. In particular, FIG. 1 illustrates an illustrative environment for managing the software and processes in accordance with the invention. To this extent, the environment includes a network entity such as server 101 that can perform the processes described herein. Alternatively, the server may be other network entity. Server 101 may be located at any physical place or cloud environment selected by the software application provider. In particular, Server 101 includes a computing device 102. Computing device 102 may include program code logic 103 (one or more software modules) configured to make computing device 102 operable to perform the services described herein. The implementation of program code logic 103 provides an efficient way in which computing device 102 send content to a user device 104 at certain locations. Program code logic 103 can be contained in more than one computing modules, and may be stored in memory 107.

By way of illustration, program code logic 103 will receive user device registration information from the user associated with user device 104. The registration information can include, for example, certain rules, identification information, payment methodology, such as information regarding an online payment service, credit card information, and/or bank account information, etc. The rules can dictate the type of content to be received, which may be content compatible with the user device such as, for example, audio, text, streaming video or graphics, or any other content. The rules or other information can also be specific to geolocations such as tolling system plazas, parking garages, transportations venues such as bridges or highways, and any other areas that the user may pass within or through.

The user associated with user device 104 can also enter contact information, for example, an electronic mail address or user identification, biometric authentication information to allow for login credential, such as, keyboard pattern, fingerprint, retinal print, voice recognition and the like), information associated with the user, such as a license plate, vehicle model, and the like, as well as preferred message types. The message types can be sent by short message service (SMS), session initiation protocol (SIP), small mail transport protocol (SMTP), Web Services, rich site summary (RSS) feed or ATOM synchronization format based feed, and/or user device vibrating or flashing, for example. The rules and other information can be stored in storage system 110. Further, users may register or login from any fee based or non-fee based social media platform, and may be authorization for the software to obtain additional information on the user from such social media platform.

Upon registering with program code logic 103, the location of the user can be provided to computing device 102 upon a triggering event. The triggering event may be that user device 104 arrives at a certain geolocation, the program code logic 103 will obtain information from user device 104, and query whether the user would like to pay a given fee associated with the geolocation. Server 102 may either already have stored the fee associated with a given geolocation, or may be able to request from another network entity the fee associated with a given geolocation. Alternatively, the user may set up the user device such that payment is automatically made with no further notification or input from the user. Payment may be made by a variety of means. For instance, in one embodiment, the triggering event results in the user device 104 sending a communication to the owner or controller of the geolocation (example: toll booth, metro stop, parking facility or space) or the means of accessing the geolocation (example: bus, train, and other transportation means), where the communication contains user information associated with the user device 104. User information in this regard may be one or more of the user customer identification number, time and date of the triggering event, and payment information. The owner or controller may then either charge the payment directly to the user, or the user may automatically or manually pay the payment. In an alternative embodiment, the owner or controller of the geolocation provides a third party platform provider with a billing schedule indicating when the user device 104 has utilized the services or facilities of that geolocation, where payment is made via the third party platform provider. The fees charged by the third party platform provider may include fees for any use of the services or facilities of that geolocation, such as tolls per vehicle, tolls per axle, flat fees, payment per unit time, permit fees, HOV/speed fees, bus/train/metro fees, fees for time charged based on length of time, and fees according to a fee schedule provided by the owner or controller of the geolocation, including but not limited to a municipality, university, stadium authority, or third party.

In some embodiments, program code logic 103 will transform or format the content, to ensure that it is compatible with the user device of the participant. For example, program code logic 103 can check the preferences of the user device to ensure that the device is capable of the message or other media that the system may send. For example, program code logic 103 may check that the user device is capable of receiving a picture having a 640×428 pixel format. If the device is not capable of receive multimedia, program code logic 103 may send a text message via SMS to the user device, which may include a uniform resource locator (URL) to a website containing information relevant to the user. Also, in some embodiments, as the system is dynamic, program code logic 103 can change the information based on the movements of the participant. A participant's device can transmit its location to program code logic 103 by using, for example, GPS, assisted GPS (A-GPS), triangulation methodologies, or any other method, including the use of other mapping applications.

In certain embodiments, a payment charging platform 105 is maintained to provide charging models to charge for services rendered. The charging system 105 is an electronic money payment system which allows payment to be processed from a user associated account, including but not limited to any bank account, credit card, online payment service, or standard debit cards. Charging platform 105 may include a processor, memory comprising computer program code, a transceiver, and/or any other hardware that may be used to perform any of the processes described herein.

Charging platform 105 may be maintained, deployed, created, and/or serviced by a service provider and/or by a third party. Charging platform 105 is designed to generate a charging record for services rendered to a subscriber, for example, the user may be charged for the services rendered based on the charging model implemented by certain embodiments of the system and/or method described herein. In certain embodiments, the service provider and/or program code logic can calculate an amount to be charged, based on many different considerations and generate the charging record to be sent to charging platform 105. In turn, charging platform 105 can generate an invoice and/or deduct a usage charge from an account of the subscriber.

Computing device 102 also includes a processor 106, the memory 107, an input or output (I/O) interface 108, a bus 109, and/or a transceiver used to facilitate wirelessly or wired communication with user device 104 and/or charging platform 105. Memory 107 can be removable or non-removable, and can include local memory employed during actual execution of program code, bulk storage, and cache memories which provide temporary storage of at least some program code in order to reduce the number of times code must be retrieved from bulk storage during execution. In addition, the computing device includes random access memory (RAM) and a read-only memory (ROM).

Computing device 102 may be in communication with the external I/O device/resource and storage system 110. For example, I/O device 108 can comprise any device that enables an individual to interact with computing device 102 or any device that enables computing device 102 to communicate with one or more other computing devices or network entities using any type of communications link. The external I/O device/resource may be for example, a handheld device or monitor.

In general, processor 106 executes the computer program code, which is stored in the memory 107 and/or storage system 110. While executing computer program code, processor 106 can read and/or write data to/from memory 107, storage system 110, and/or I/O interface 108. Processor 106 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors. The program code executes the processes of the invention. Bus 109 provides a communications link between each of the components in computing device 102.

Computing device 102 can comprise any general purpose computing article of manufacture capable of executing computer program code installed thereon, for example a personal computer, server, handheld device, or any other network entity. However, it is understood that computing device 102 is only representative of various possible equivalent-computing devices that may perform the processes described herein. To this extent, in embodiments, the functionality provided by computing device 102 can be implemented by a computing article of manufacture that includes any combination of general and/or specific purpose hardware and/or computer program code. In each embodiment, the program code and hardware can be created using standard programming and engineering techniques, respectively.

Similarly, server 101 is only illustrative of various types of computer infrastructures for implementing the invention. For example, in embodiments, server 101 comprises two or more computing devices (e.g., a server cluster) that communicate over any type of communications link, such as a network, a shared memory, or the like, to perform the process described herein. Further, while performing the processes described herein, one or more computing devices on server 101 can communicate with one or more other computing devices external to server 101 using any type of communications link. The communications link can comprise any combination of wired and/or wireless links, any combination of one or more types of networks, such as, the Internet, a wide area network, a local area network, a virtual private network, and/or utilize any combination of transmission techniques and protocols.

Certain embodiments may provide certain features based on a subscription, advertising, transaction, and/or fee basis. That is, a service provider could offer to perform the processes described herein. In this case, the service provider can create, maintain, deploy, and/or support, the computer infrastructure that performs the process deployed by certain embodiments for one or more customers. The participants may be, for example, a user of a mobile device or a vehicle. In return, the service provider can receive payment from one or more customers and/or participants under a subscription and/or fee agreement. In some embodiments, the service provider can receive payment from the sale of advertising content to one or more third parties.

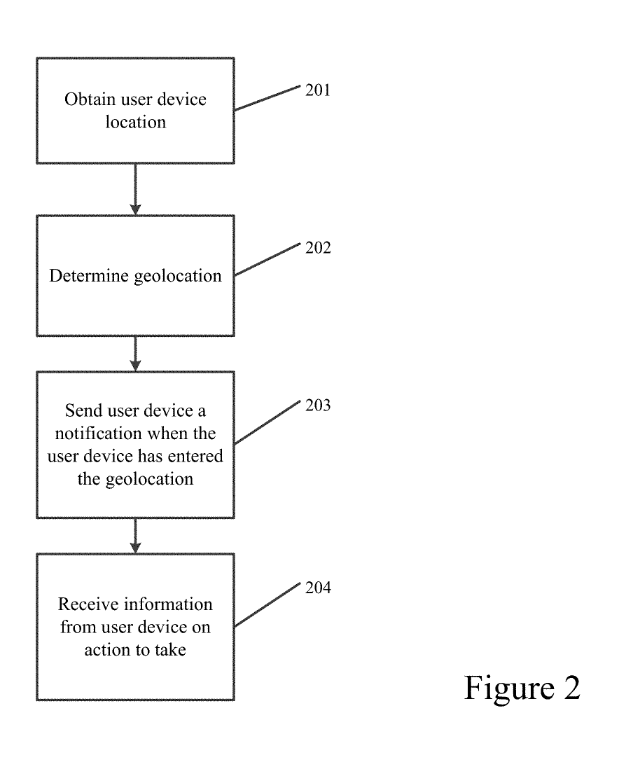

FIG. 2 illustrates a flow diagram according to certain embodiments. In particular, FIG. 2 illustrates a geolocation and payment process in accordance with certain embodiments. The steps shown in FIG. 2 may be processed by the software based application using hardware being operated in the user device and/or a network entity that is located externally to the user device. As shown in step 201, the user device location may be obtained from the user device 104. The location may be determined by the user device 104 using any possible method, for example, GPS, A-GPS, cell tower triangulation, other triangulation methodologies, or a mapping application used by user device 104. In other embodiments, the user may alternatively, or in addition to, enter the geolocation of the device manually by inputting a physical address or its position relative to a point of interest or a physical landmark. The location information of the user device may be sent from user device 104 to server 101 or any other network entity operated by a service provider.

The geolocation of the user device may also be determined by server 101. The geolocation may be pre-set or pre-programmed or defined into the software or hardware of server 101, or any other network entity, by the service provider. The geolocation may be any point of interest by the service provider, such as a toll booth, parking location, street block, metro entrance or exit, metro stop, bus stop location, ferry entrance or exit, restaurant, business, or any other point of interest. In some embodiments, the geolocation information can be updated periodically in order to change, add, or otherwise modify the information as new information becomes available. In certain embodiments, the information may also be updated in order to refresh or reorganize the information. The reorganization may be used to maintain interest by repeat participants. Advantageously, as the user devices of the participants are independent of the system of the invention, in certain embodiments no updates may be made to individual, dedicated devices. Updates may, in some embodiments, only occur on the network end, as opposed to the user end.

More specifically, the system and method of the present invention uses geographic locations to determine a position of a participant and, based on this positional information, provide relevant information to the participant associated with the geolocation of the user device. For example, the relevant information associated with the geolocation may be at least one of the geolocation name, cost of entering, parking, or passing through the geolocation, and the like.

The system may comprise at least one or more computers containing at least the typical computer components (processor, memory, transceiver, an I/O interface, and a bus). The computer may store a database in its memory containing information such as the pre-determined geolocation of areas of interest, such as toll booths, parking lots, and/or metro stops, and the associated costs, if any, with use of those geolocations. In certain embodiments, the costs may be a flat fee, a cost per unit time, a cost per parking spot, and/or a cost per toll passed, or any other cost. The computer may be physically located at the geolocation, or may be located remotely in another facility, or in a cloud environment. The database may also contain information relating to cameras or other monitoring devices associated with the geolocation. In the above embodiment, the database may not be located in server 101. Server 101 may communicate with the computer or cloud environment in which the data base is stored, and determine the geolocation based on such information. In other embodiments, however, the database may be located in server 101.

A software based application is configured to register user device 104 with the location based services software. The software application is also configured to obtain and store preferences and other information related to user device 104. The preferences can include, for example, the types of content that can be supported on the user device display such as, for example, audio, video, and/or text. The preferences and other information can also include the type of preferred content to be provided to user device 104, such as automatic payment upon entering geolocation and notification of user device 104, or request that user device 104 elect whether to pay a fee for entering or accessing the geolocation or to refuse to pay a fee, notification and alert settings, and other. The user preferences may be stored on the user device, or store remotely on a different computer.

When the software determines that the user device 104 has entered a pre-determined geolocation 202, by comparing the user device location to the stored geolocation information, server 101 sends a notification to the user on the user device 104 that they have entered the pre-determined geolocation 203. The notification can occur by one or more communication types, such as verbal notification, banner presentation, user device vibration or camera flash flashing, sound, or ZT supplied sound, SMS, SIP, SMTP, Web Services, RSS feed or ATOM based feed, for example. Sounds for voice settings may include one or more accent choices, such as a British, Spanish, French, and/or comedic voices from various movie characters. The notification may also be used to alert the user that registration is required, and to request the user stop the vehicle, register the vehicle or the user, obtain authorization for a completed registration, and entering a vehicle license plate number.

Upon receiving the notification from the network entity that the user device has entered a geolocation, the user device may determine an action based on the information. For example, the action may be to pay a fee for a given parking spot, for going through a toll, for using a transportation system, or for accessing any time of facility. The action may also include asking for more information pertaining to the geolocation. For example, the action may include the user device requesting more information about a parking spot in a parking lot, a transportation system, and/or a toll road. In step 204 the software based application operating on hardware may receive information from the user device relating to the action chosen by the user device. The software based application may then respond based on the action requested by the user device.

The software based application may likewise include features such as password recovery, use of different sound effects that are each associated with an event, and the like. For instance, the software may employ a different sound effect for approaching, entering, or leaving a geolocation, authorizing payment, payment being declined, non-payment, and voice sound effects to issue warnings, such as, for example, clapping, horns, cash register dings, and the like.

Depending upon the user settings associated with the user device 104, the software will either authorize automatic payment of a fee required to use or access the geo-location, send the user device a notification requesting a manual payment of a fee associated with the geolocation, or request that user device 104 query the user on whether to authorize payment. In some embodiments, the software operating with user device 104 tracks the location of user device 104, thereby being able to determine when the user device 104 enters or leaves a geolocation. That is, the software can pass the unique identifier of user device 104 and the geolocation back to the server.

In addition, a facility at the geolocation may be equipped with equipment used to track the user device 104. In one non-limiting example, a camera by itself or associated with a movement sensor may be utilized by a facility or structure located at the geolocation to determine each person or vehicle that enters and exits the geolocation, along with the time and date associated with the geolocation entry and departure. The captured images may be any image of information associated with a vehicle or person, such as automobile license plate, and/or stickers or tags on the vehicle that provide vehicle identifiers, for example, bar code or any other code in the vehicle. The tracking equipment of the facility at the geolocation may be configured to communicate with other tracking equipment, for example other cameras, or may be configured to communicate directly with the computer, for example, server 101 or the computers on which the database of the geolocation is located, via a communication link. The communication link may be a category 5 cable (CATS), WLAN, cellular network, or any other method of communication.

The tracking equipment at the geolocation may be utilized further by the software, or the hardware upon which the software is operating, to determine if the person associated with the user device 104 has properly paid or failed to pay for entry or use of the geolocation or its facilities.

In other embodiments, the software, or the hardware upon which the software is operating, may generate reports or conduct data analytics on the use of a specific geolocation or a user device. Examples include the number of passages for each geolocation, total charges per each geolocation, and/or other information such as the average time lost by a geolocation for each user device passage.

Some embodiments may be utilized for having a user, and associated user device 104, pay a toll upon the passing of a toll booth. The software, or the hardware upon which the software is operating, may generate an alert upon the user device approaching a geolocation. The timing of the alert may be based on the number of miles the user device is away from the geolocation, and an estimated time upon entry, utilizing speed of travel of the user device. In other words, the notification or alert may be sent in anticipation of a user device entering the geolocation. The software may ask the user if they want to pay for the toll using the software application, and ask the user to confirm the vehicle license plates for the toll, if more than one vehicle is registered, and/or to enter the license plates, if the user is merely a passenger and not a driver of the vehicle.

In certain embodiments, the software may also give safety advice and requests depending upon the specific circumstances, and give statistics on use of the software in the user device and/or the vehicle, such as time, fuel, and greenhouse gasses saved to date by use the application. The software, or the hardware on which the software is operating, may also regularly remind the user via notifications to register vehicles, register or update payment information, and the like. One further embodiment is to utilize the software, or the hardware on which the software is operating, for payment of location based taxes for use of a facility and/or transportation pathway, such as a bridge, speed lane, road, ferry, and the like.

In some embodiments, the facility or structure associated with a geolocation, such as a tolling booth or parking garage, may take a series of pictures of persons and/or vehicles in one or more lanes at the geolocation, and associate each picture with a time stamp. A time stamped picture may be selected from the one or more pictures, and compared to information regarding a person and/or vehicle passing through or by a geolocation lane without authorizing payment, in violation of the payment policies of the facility or structure. When it is determined that the violator did not authorize payment, and the time stamped picture yields identifying information on the violator such as a license plate, identification number, or any other identifying information of the person or vehicle, than the person or vehicle in the time stamped picture is identified as the violator. The selected picture is also compared to a database containing information on the user and/or user device 104. If the violator is also present in the database, then the software, or the hardware on which the software is operating, may query the user associated with the user device to make payment, even though the user has already passed by or through the geolocation. Further, the software, or the hardware on which the software is operating, may query records of payment by the violator, and compare to payment authorized by the software, and adjust payments or charges accordingly to ensure the user is not overcharged, such as double billed, or undercharged.

In some embodiments, the pictures taken by the facility at the geolocation may be associated with specific lanes, or may not be associated with specific lanes. The series of pictures may include a first time gap having a predetermined duration of time before entering the facility or building associated with the geolocation, and a second time gap upon leaving the facility or building. In one embodiment, the time gap may be between 1 second to 1 minute, or between 2 seconds and 10 seconds.

In one embodiment, the software based application is used to pay for use of a transportation system. In this embodiment, geolocation of transportation system terminals, stops, or locations is predetermined and utilized by the software. The position of a participant is determined by the user device, The transportation terminal may be, for instance, a rapid transit location, train stop location, bus stop, and/or taxi stop. Upon a user device reaching the geolocation of a transportation terminal, the software may present information regarding the transportation terminal to the user of the user device. The transportation terminal name, cost of entering or using of the transportation terminal, or any other information associated with the transportation terminal. The software based application, depending upon the user settings, may automatically authorize payment to the transportation terminal authority responsible for collecting such payment. Alternatively, the software may manually query the user device to elect whether to pay a fee for entering or use the transportation services associated with the geolocation, or to refuse payment.

In yet another embodiment, the software may inform or notify the user device when the user device reaches the geolocation of a transportation terminal, and request that user device query the final destination transportation terminal that the user device participant desires to go to using the transportation system. For example, the user device may solicit or request the user to input the destination rapid transit stop, train stop, taxi stop, or a physical address. The software based application may at that time calculate the cost of using the transportation system and request the user device authorize payment, or have the user device automatically authorize payment, depending upon the software settings. The setting may either be predefined or set by the user of the user device.

The transportation system terminals may use equipment or devices to track the location and movement of the user device, such as cameras associated with the transportation terminal, or other tracking or identification technology. For example, the software based application may utilize other mapping applications in the user device to aid in tracking the location of the user device. The tracking technology may associate a date and time with the detection of the user device, which may further be used with the software or by the transportation terminal authority to determine if the user of the user device properly paid or failed to pay for entry or use of the transportation terminal. The user device tracking information may also be used to reconcile payments by the user device with use of the transportation facilities. This may help to ensure that the user associated with the user device properly paid for use of the transportation system, and to ensure the user was not billed more than once for each use of the transportation system.

Certain embodiments may help implement an almost real-time parking system. This embodiment requires that the database located in server 101 or in the external computer contains a database listing the parking spaces in a certain geographical region, along with characteristics specific to that space. The characteristics can include, but are not limited to, cost of parking per unit time, whether use of the parking space requires an additional parking permit issued by a government agency, university or business, restrictions in using that parking space, parking space assignment, the number or character assigned to each parking space, and any other information related to a given parking space in the parking facility.

Ideally, preferred embodiments lack parking-specific hardware or devices, such as parking sensors or meters, and instead requires software that interacts with, or resides upon, a use device, mobile device, or vehicle of the user. However, it is envisioned that in one alternative embodiment, the parking space may also have a sensor that determines whether a parking space is occupied by a motor vehicle.

The computer and/or server 101 may also tracks which parking spaces are in use and which spots are vacant. When a user desires to use a specific parking space, the user device may access the software based application located on the user device or accesses software located remotely, via WLAN, cellular communication, or using any other method of communication. The user device may communicate with the database that the user is occupying a certain spot, and then again may inform the database when the user leaves the parking space. In one embodiment, the user must enter the number or character assigned to the selected parking space, payment information, and the like. The software based application may begin a timer to calculate the cost charged for using the parking space, and the user device receives authorization to use the selected parking space. The database may be updated to notate that the specific parking space is occupied. When the user desires to vacate the selected parking space, the user device communicates the intent of the user to leave the space and notifies the server, computer, and/or the network entity. The cost of using the space may then be calculated and charged to the user payment system. The database may likewise be updated to note the parking space is vacant. By using this methodology iteratively over time, the database can accurately state which parking spaces are vacant and available.

The user device, in certain embodiment, can also use the software based application to request information located in the parking space database in advance, such as cost to park per unit time, available parking spaces, and/or any other available information. A notification may then be sent to the user device in anticipation of the user device entering a given geolocation. As such, in one embodiment, the system is used by a user/driver to find available parking spaces. The software queries the database, which lists the available spaces and any restrictions, if any, on use of that space. As a result of the embodiments discussed above, the parking location may not require any physical devices such as parking meters or parking sensors which detect if a space is occupied.

In some other embodiments, the systems and methods discussed herein may be utilized when a user of the user device desires to pay for use of a space, a road lane, such as an HOV lanes or toll a lane, parking space, parking lot, or use of a certain transportation system. Other embodiments may be used when a user of the user device desires to pay for movement through or access to a certain area, such as access to a park, trails, tours, theme parks, entertainment arenas or stadiums, or access to any other facility.

For each embodiment, one or more steps may be implemented on the computer infrastructure of FIG. 1. Each process of the software may represent a module, segment, or portion of code, which comprises one or more executable instructions for implementing the specified logical function(s). It should also be noted that, in some alternative implementations, the functions noted in any block of any figure may occur out of the order noted in the figures. For example, two blocks shown in succession may, in fact, be executed substantially concurrently, or the blocks may sometimes be executed in the reverse order, depending upon the functionality involved. Each block of the flow diagram, and combination of the flow diagram can be implemented by special purpose hardware-based systems that perform the specified functions or acts, or combinations of special purpose hardware and computer instructions and/or software, as described above.

Additionally, the invention can take the form of an entirely software embodiment or an embodiment containing both hardware and software elements. Software includes but is not limited to firmware, resident software, and/or microcode. Furthermore, certain embodiments can take the form of a computer program product accessible from a computer-usable or computer-readable medium providing program code for use by or in connection with a computer or any instruction execution system, where such software based applications are downloaded from an online store.

The software and/or computer program product can be implemented in the environment of FIG. 1. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. While the invention has been described in terms of embodiments, those skilled in the art will recognize that the invention can be practiced with modifications and in the spirit and scope of the appended claims.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

1. A method comprising:
obtaining a location of a user device;
determining a geolocation of the user device based on the obtained location;
sending the user device a notification when the user device has entered the determined geolocation; and
receiving information from the user device relating to an action chosen by the user device.

2. The method according to claim 1, wherein the geolocation information is predefined in a database in either the network entity or another network entity.

3. The method according to claim 2, wherein the database is updated based on information received from the user device.

4. The method according to claim 1, further comprising:
obtaining at the network entity the geolocation from another network entity.

5. The method according to claim 1, further comprising:
obtaining preferences of the user device; and
determining the geolocation based on the preferences of the user device.

6. The method according to claim 1, further comprising:
automatically drawing a fee associated with the geolocation from the user device.

7. The method according to claim 1, further comprising:
sending the user device a notification requesting a manual payment of a fee associated with the geolocation.

8. The method according to claim 1, further comprising:
transmitting to the user equipment a notification requesting that a user of the user device register at the determined geolocation.

9. The method according to claim 1, further comprising:
transmitting a notification to the user device in anticipation of the user device entering the geolocation.

10. The method according to claim 1, wherein a notification sent from the network entity to the user device triggers a sound at the user device, wherein the sound is based on a content of the notification.

11. The method according to claim 1, further comprising:
receiving the location of the user device from a facility at the geolocation.

12. The method according to claim 1, further comprising:
receiving a report comprising information related to utilization of the geolocation by the user device.

13. The method according to claim 1, wherein the geolocation is at least one of a toll booth, a parking lot, or a transportation terminal.

14. The method according to claim 1, further comprising:
determining that the user device is located in the geolocation in violation of a payment policy of a facility at the geolocation.

15. The method according to claim 1, wherein the action by the user equipment relates to a given spot in a parking facility at the geolocation, a given stop in a transportation system at the geolocation, or a given toll booth at the geolocation.

16. The method according to claim 1, wherein the information is received from the user device in hardware within the user device on which a software based application is operated.

17. An apparatus comprising:
at least one memory comprising computer program code;
at least one processor;
wherein the at least one memory and the computer program code are configured, with the at least one processor, to cause the apparatus at least to:
obtain a location of a user device;
determine a geolocation of the user device based on the obtained location;
send the user device a notification when the user device has entered the determined geolocation; and
receive information from the user device relating to an action chosen by the user device.

18. The apparatus according to claim 16, wherein the apparatus is the user device upon which an software based application operates.

19. A method comprising:
sending a location of a user device;
receiving at the user device a notification when the user device has entered a determined geolocation;
choosing an action at the user device based on the received notification; and
sending information from the user device relating to the chosen action.

20. The method according to claim 18, wherein the information is sent from the user device to hardware within the user device on which a software based application is operated.
